(19) United States
(12) Patent Application Publication
(10) Pub. No.: US 2023/0019210 A1
(43) Pub. Date: Jan. 19, 2023

(54) COATING REPAIR KIT

(71) Applicant: Elcometer Limited, Manchester (GB)

(72) Inventor: Jack A. Mitchell, Brighton (CA)

(21) Appl. No.: 17/934,307

(22) Filed: Sep. 22, 2022

Related U.S. Application Data
(63) Continuation of application No. PCT/US2021/023969, filed on Mar. 24, 2021.
(60) Provisional application No. 62/994,002, filed on Mar. 24, 2020.

(51) Int. Cl. F16L 55/168

(52) U.S. Cl. CPC F16L 55/1683

(57) ABSTRACT

A coating repair device for repairing a defect in a paint or coating by forming a repair patch around and over the defect. The repair device comprising a flexible member having an inner section peripherally surrounded by an outer section, each section having top and bottom surfaces with the bottom surface of the inner section being recessed with respect to the bottom surface of the outer section, such that when the flexible member is, in use, placed on the surface of a coating to be repaired it defines a cavity with the surface. An injection through-hole extends between a top and bottom surface of the device for the introduction of repair material into the cavity, in use, and one or more relief through-holes extend between the bottom and top surfaces of the device through which, in use, displaced air or surplus repair material may flow out of the cavity.

### CROSS REFERENCES TO RELATED APPLICATIONS

This Patent Application is a Continuation of International Patent Application No. PCT/US2021/023969, entitled “Coating Repair Kit and Method of Repairing a Pipe,” filed Mar. 24, 2021, which claims priority to U.S. Provisional Patent Application 62/994,002, filed Mar. 24, 2020. Both of the afore-mentioned applications are incorporated herein by reference in their entireties.

### TECHNICAL FIELD

The present disclosure relates to coating repair devices and kits and to a method of repairing coatings. The disclosure relates in particular to the repair of coatings, (including membranes) on metal substrates, for example those covering metal pipes, tank linings or structural steel on what would be considered critical assets. Critical assets would be assets that is filled with a liquid such as large storage tanks containing oil, gas or water or buried such as oil and gas transmission pipelines.

### BACKGROUND

In the oil and gas servicing industry, pipes are typically exposed when either a defect has been detected or for routine maintenance. Metal pipes through which the hydrocarbons flow are coated on the outside with resinous based coatings or membranes. Any defect in this coating, such as a pinhole or holiday, results in exposure of the metal surface to the environment resulting in premature corrosion of the metal surface, potentially leading to a rupture or spill.

Currently there is no standardized repair solution for addressing the repair of small area defects or holidays on pipeline coatings, tank linings or coatings of structural steel members. Once holiday testing or spark testing has been performed on the critical assets, and areas in need of repair are identified, each repair may be conducted differently depending on the preference of the person performing the repair. Generally, the process of repair is also time consuming and labour intensive. Since the repairs may be carried out in different ways by different personnel, there is often a lack of consistency in the ways that repairs are effected and this can lead to a potential for failure of the repairs.

It is therefore an object of embodiments of the present disclosure to at least partially overcome the above issues.

### SUMMARY

According to a first aspect of the present disclosure, there is provided a coating repair device comprising a flexible member having an inner section peripherally surrounded by an outer section, the inner and outer sections each having top and bottom surfaces with the bottom surface of the inner section being recessed with respect to the bottom surface of the outer section, such that when the flexible member is, in use, placed on a surface of a coating to be repaired it defines a cavity with the surface, and an injection through-hole extending between a top surface of the device and the bottom surface of the inner section for the introduction of repair material into the cavity, in use, and one or more relief through-holes extending between the bottom surface of the inner section, at the outer periphery of the inner section, and a top surface of the device through which, in use, displaced air or surplus repair material may flow out of the cavity.

Thus, embodiments of the present disclosure provide for a flexible coating repair device that may easily fit over and around a defect in a coating to provide a cavity between the bottom surface of the inner section and the coating into which, in use, a repair material may be introduced via the injection through-hole to repair the defect. The device can thus be configured to enable repair material to be introduced in a predetermined thickness, area and shape providing for convenient and consistent application irrespective of operator. As the device is flexible it can be used to repair defects in coatings on surfaces that are convex, flat or concave as the repair device will change shape to conform to multiple surfaces, such as, but not limited to, those of pipelines, penstocks, tank linings or rail car linings. The flexibility also allows the device to be peeled off the coating after use, leaving the repair material undamaged and attached to the coating. The coating repair device is also easy to use and therefore saves time and labour involved compared with existing coating repair systems.

A top surface of the device may be defined by the top surfaces of the inner and outer sections. A bottom surface of the device may be defined by the bottom surfaces of the inner and outer sections.

The inner section may be planar. Accordingly, the inner section may be an inner cavity membrane section. The inner section may be substantially circular. The inner section may have a diameter of at least 20 mm, 30 mm, 40 mm, 50 mm, 60 mm, or 70 mm. The inner section may have a diameter of less than 80 mm, 70 mm, 60 mm, 50 mm, 40 mm, or 30 mm. Preferably, the inner section has a diameter of about 40 mm.

The outer section may be planar. The outer section may be an annulus.

Accordingly, the outer section may be an outer annular membrane ring section. The outer section may have an outer diameter of at least 50 mm, 70 mm, 90 mm or 110 mm. The outer section may have an outer diameter of less than 130 mm, 110 mm, 90 mm, 70 mm, or 50 mm. Preferably the outer section has an outer diameter of about 64 mm. The difference between the inner and outer diameter of the outer section may depend on the depth of the recess between the bottom surfaces of the inner and outer sections, and/or the diameter of the inner section. The outer diameter of the outer section may be at least 5 mm, 10 mm, 15 mm, 20 mm, or 50 mm greater than the inner diameter of the outer section.

Accordingly, the inner section and outer section may have a circular shape with the inner section being concentric with the outer section.

The majority of the bottom surface of the inner section may be recessed from the bottom surface of the outer section by a given height. Accordingly, the bottom surface of the inner section may be raised above the bottom surface of the outer section by height T. T may be at least 0.1 mm, 0.25 mm, 0.5 mm, 0.75 mm or 1 mm. T may be less than 2 mm, 1 mm, 0.75 mm, 0.5 mm, or 0.25 mm. Preferably, T is 0.6 mm. Thus, a repair patch created by the device may have a low form factor and be less likely to be accidentally damaged or removed from the coating.

The bottom surface of the inner section may be smooth. Thus, the repair material is unable to strongly bond to the bottom surface and thus the coating repair device can be easily removed from a cured repair patch without damaging the repair patch.

The inner section may comprise a outer periphery configured to connect the bottom surfaces of the outer and inner sections. There is preferably a smooth, rather than stepped, transition between the inner and outer sections. In particular, the outer periphery of the inner section may be chamfered at an angle of at least 22.5 degrees, 45 degrees, or 67.5 degrees with respect to the bottom surface of the outer section. Preferably the outer periphery is chamfered at an angle of 45 degrees with respect to the bottom surface of the inner section. The outer periphery may have a width in a direction the parallel to the bottom surfaces of the inner and outer sections of least 0.25 mm, 0.5 mm, 0.75 mm or 1 mm. The width of the outer periphery may depend on the depth of the recess between the bottom surfaces of the inner and outer sections and/or the diameter of the inner section. Accordingly, the peripheral connection of the outer periphery of the inner cavity membrane section to the outer annular ring section may be chamfered. Advantageously this reduces the likelihood of damage to a repair patch that is created by the device. In particular, it reduces the likelihood of soil or liquid damage to the repair patch.

The or each relief through-hole may extend perpendicularly with respect to the bottom surface of the inner section and/or the bottom surface of the outer section. The or each relief through-hole may extend between the top and bottom surfaces of the inner section. The or each relief through-hole may be straight. The or each relief through-hole may have a width of at least 0.5 mm, 1 mm or 2 mm. There may be a plurality of relief through-holes. Where there are two or more relief through-holes, they may be equally spaced around the outer periphery of the inner section. There may be 3, 4 or more relief through-holes. Preferably, there are 4 relief through-holes arranged around the outer periphery of the inner section. Thus, the relief through-holes can be designed and positioned to ensure that, in use, all air in the cavity is displaced out the cavity through the relief through-holes while repair material enters the cavity through the injection through-hole.

A portion of the bottom surface of the inner section surrounding the injection through-hole may be recessed with respect to a remaining portion of the bottom surface of the inner section. The portion of the bottom surface of the inner section surrounding the injection through-hole may be recessed by at least 0.1 mm, 0.2 mm, 0.3 mm, or 0.5 mm (preferably 0.3 mm) with respect to a remaining portion of the bottom surface of the inner section. The diameter of the portion may be at least 10 mm or 20 mm, preferably 12 mm. The bottom surface surrounding the injection through-hole may taper towards the injection through-hole. The bottom surface surrounding the injection through-hole may be tapered at an angle of at least 0.5 degrees, 1 degree, or 2 degrees (preferably 1 degree) with respect to a remaining portion of the bottom surface of the inner section. As such, in use, repair material surrounding the through-hole has a thickness greater than elsewhere, increasing the strength/resilience of the repair material in a position corresponding to the defect.

The opening to the injection through-hole for the introduction of repair material in the bottom surface of the inner section may be disposed substantially centrally in the inner section. The injection though-hole may extend substantially at right angles to the bottom surface of the inner section. The injection through-hole may extend between the top and bottom surfaces of the inner section. Thus, the injection through-hole is positioned to ensure that, in use, repair material enters the cavity at its centre and is therefore more likely to displace all air in the cavity and completely filling the cavity with repair material. This provides for a better and more effective repair patch.

The injection through-hole may be tapered. The injection through hole may be tapered adjacent to the bottom surface of the inner section. The injection through-hole may narrow as it approaches the bottom surface of the inner section. The diameter of the injection through-hole at the bottom surface of the inner section may be smaller than the diameter of the part of the injection through-hole that connects to the bottom surface of the inner section. The injection through-hole may have a substantially circular cross-section. The diameter of the through-hole at the bottom surface of the inner section may be least 0.25 mm, 0.5 mm, 0.75 mm or 1 mm. The diameter of the through-hole at the bottom surface of the inner section may be less than 2 mm, 1 mm, 0.75 mm, or 0.5 mm. Preferably, the diameter of the through-hole at the bottom surface of the inner section is about 0.8 mm. Preferably, the tapering of the injection through-hole reduces the diameter of the injection through-hole by at least 20%, 30%, 40%, 50%, or 60%. Thus, the injection through-hole is narrower at the point it meets the bottom surface of the inner section and thus there is a local point of weakness in injected repair patch material at this point. During removal of the coating repair device, this point of weakness in the repair patch material preferentially breaks flush to the top of the repair patch which results in a smoother repair patch that is less likely to be caught on other objects and damaged. Furthermore, the tapered injection through-hole retains repair material that has cured within it and prevents this from falling onto the repair patch during removal of the device from the coating, whilst encouraging the material to break at the point of weakness.

A fitting may be provided on the top surface of the inner section in communication with the injection through-hole. The fitting may be configured to receive apparatus for delivering repair material to the coating repair device. The fitting may be disposed on/around the injection through-hole. The fitting may be any suitable type of connector, such as an interference fit, push-fit, bayonet, or screw connector. The apparatus for delivering repair material to the coating repair device may be a repair material dispensing device. The fitting may define an injection port. The fitting may be tubular. The injection port may have a substantially circular cross-section. The fitting may extend away from the top surface of the coating repair device. The fitting may be tapered such that its inner diameter increases as the distance from the injection through-hole increases. The fitting may be tapered such that its outer diameter decreases as the distance from the injection through-hole increases. The fitting may be tapered such that at a distal end of the fitting distal the injection through-hole, the inner diameter is at least 0.05 mm, 0.1 mm, or 0.25 mm larger than at a proximal end of the fitting adjacent the injection through-hole. The fitting may be tapered such that the outer diameter is at least 0.1 mm, 0.25 mm, 0.5 mm larger at the proximal end of the fitting than at its distal end. Accordingly, the fitting may be an injection port attached to, and located on, the inner section, which is configured to receive therein a dispensing tip or nozzle of a repair material dispensing device. Thus, the fitting allows for repair material to be accurately and easily delivered to the cavity through the injection through-hole.

The fitting may allow apparatus for delivering repair material to the coating repair device to be received by the coating repair device at various angles with respect to the top surface of the inner section. The fitting may be perpendicular to the top surface of the inner section. The fitting may not be perpendicular to the top surface of the inner section, such as at an oblique angle to the top surface of the inner section. The fitting may allow repair material to be introduced to the coating repair device at various locations on the top surface of the inner section. Thus, the fitting and injection through-hole may be flexibly designed to suit the access requirements of the coating to be repaired. This can allow hard to reach areas to be conveniently repaired without necessarily having direct access to the defect.

The coating repair device may comprise a tab. The tab may be configured to allow the coating repair device to be removed from a coating after use. The tab may be attached to one side of the outer periphery of the outer section. The tab may be any suitable shape such as circular, or rectangular. The tab may be planar. The tab may have a width in the plane of the inner section that is less than the diameter of the inner section. The tab may be angled with respect to the inner and outer sections. The axis of the tab may be angled with respect to the axis of the inner section such that their axes converge at a point above the top surface of the coating repair device. The tab may be annular with an outer circumference that is smaller than the outer circumference of the inner section. The tab may be a thumb grab. Accordingly, the tab may be a grippable tab extending from an outer periphery of the outer section having a size suitable to be gripped by a user for peeling the device off the surface of the substrate once an injected repair material has cured. Thus, the tab allows a user to easily remove the coating repair device in a controlled manner that increases the likelihood of successfully repairing the defect.

The coating repair device may be formed of a single piece of material, such as by moulding. Alternatively, the coating repair device may be formed of separate parts joined together. Any one or more of the inner section, outer section, and tab may all have the same, or a similar, thicknesses. Preferably the thicknesses of the inner section, outer section, and tab are all within 1 mm, or 0.75 mm, 0.5 mm, or 0.25 mm of each other. The thickness of any one or more of the inner section, outer section, and tab may be at least 0.5 mm, 1.0 mm, 1.5 mm, or 2.0 mm. The thickness of any one or more of the inner section, outer section, and tab may be at less than 5 mm, 2.0 mm, 1.5 mm, or 1.0 mm. Preferably, the thicknesses of the inner section, outer section, and tab may be 1.3 mm. The thickness of the coating repair device may depend on the diameter of the coating repair device and the depth of the recess between the bottom surfaces of the outer and inner sections. Accordingly, the top surface of the coating repair kit may have the same profile as the bottom surface of the coating repair kit. Alternatively, the thickness of each section may vary such that the profile of the top surface does not correspond to that of the bottom surface of the coating repair kit. Accordingly, the coating repair device may be described as a membrane. Thus, the coating repair device can be easily manufactured in a single step moulding process. Furthermore, where the thickness of the device is the same on the inner and outer sections, the user is given a convenient reference as to the size (both area covered and thickness) of the patch that will be created by the device.

The coating repair device may be made from plastics materials. The coating repair device may be made of any one or a combination of: epoxy resins, urethanes, polypropylene, homopolymers, plastics, ultra-violet curing compounds or other resinous materials. At least part of the coating repair device may be translucent or transparent. The coating repair device may allow repair material in the cavity to be seen through the top surface of the inner section. Thus, in use, the process of filling the cavity with repair material can be visually monitored by the user. This allows them to better control the process and identify any issues in the repair process immediately without having to wait for the repair patch to cure.

The coating repair device may comprise an indicia formed in relief on the bottom surface of the inner section. The indicia may be any one or more of: letters, numbers, logos, hazard warning signs, safety symbols, the date and/or time of repair, the materials used in the repair, branding or trade marks, serial numbers, etc. Advantageously, this allows a corresponding indicia to be formed on the surface of the repair patch formed during use of the coating repair device. As such, it allows for easy identification of information contained in the indicia. This can assist with future additional repairs/maintenance as well as identification of the coating repair device used to complete the repair.

An adhesive may be disposed on the bottom surface of the outer section, which in use, may adhere the coating repair device to a coating to be repaired. The adhesive may extend completely around the bottom surface of the outer section so that it completely surrounds the inner section. The adhesive may be configured to provide a seal between the bottom surface of the outer section and a coating to be repaired. The adhesive may be attached to the coating repair device prior to use. The adhesive enables the device to remain securely in place during the repair process. It also ensures that, during repair, repair material cannot flow out of the cavity between the bottom surface of the outer section and the coating.

The adhesive may comprise an adhesive film. The adhesive film may be configured to provide the adhesive and sealing functionality of the adhesive. The adhesive film may be configured to substantially cover the bottom surface of the outer section. The adhesive film may be configured not to cover the bottom surface of the inner section and/or the tab. Thus, the tab may be free from adhesive to allow it to be easily grasped by a user.

The adhesive film may be provided in register with the outer section. The adhesive film may be annular. The adhesive film may have an inner diameter the same or greater than the diameter of the inner section. The adhesive film may have an inner diameter the same or less than the outer diameter of the outer section. The adhesive film may have an outer diameter the same or less than the outer diameter of the outer section. The adhesive film can therefore be conveniently manufactured to fit the coating repair device.

The adhesive film may comprise one or more layers. Preferably, the adhesive film is a double-sided adhesive comprising two or more layers. The adhesive film may comprise a device adhesive. The device adhesive may be configured to adhere the adhesive film to the bottom surface of the coating repair device. The adhesive film may comprise a coating adhesive. The coating adhesive may be configured to adhere to a surface of a coating to be repaired. The coating adhesive may be a releasable adhesive.

The adhesive film may comprise a backing tape between two layers of adhesive. Preferably, the backing tape may not be required and the adhesive film may consist of the device adhesive and the coating adhesive. Thus, the adhesive film may be constructed from layers of material that permit convenient and cheap manufacture as well as good repair performance.

The adhesive may be configured such that, in use, the bond between the adhesive and the coating repair device is stronger than the bond between the adhesive and the coating to be repaired. Thus, during removal of the coating repair device after use, the adhesive is retained on the device and is not left behind on the coating.

A release liner may be provided over the adhesive. The release liner may be configured to prevent the adhesive from sticking to an object prior to use. The release liner may be configured to prevent dirt or other objects from touching the bottom surface of the inner section and the outer section prior to use. The release liner may be configured to cover the bottom surface of the inner section and the outer section. The release liner may be circular. The release liner may be impermeable. The release liner may have an outer diameter that is at least as big as the outer diameter of the outer section. Preferably the diameter of the release liner is the same as the diameter of the outer section. Thus, the release liner ensures the coating repair device is convenient to carry around prior to use, and that dirt is not able to reach the bottom surface of the inner section where it may detrimentally affect the performance of the device.

The release liner may comprise a release flap. The release flap may be configured to allow the release liner to be removed from the adhesive. The release flap may extend from one side of the release liner. The release flap may be rectangular. Thus, the release flap enables the release liner to be removed conveniently and quickly prior to use.

According to a second aspect of the present disclosure, there is provided a coating repair kit comprising the coating repair device according to the first aspect of the present disclosure. The coating repair kit may be used for repairing damaged or defective coatings or membranes covering metal pipes, tank linings or structural steel.

The coating repair device may include any one or more of the features of the first aspect of the present disclosure as required or desired.

The coating repair kit may comprise apparatus for delivering repair material to the coating repair device. The apparatus may be configured to introduce repair material into the injection through-hole via the fitting. The repair material source may comprise a nozzle. The nozzle may be configured to correspond with the shape of the fitting. The fitting may have a similar shape to the nozzle. Thus, the nozzle and fitting may be interference fit together. The fitting may comprise a sealing arrangement. The sealing arrangement may prevent repair material from escaping between the nozzle and the fitting during injection of repair material into the cavity in use, and/or prevent air from entering the cavity during injection of repair material in use. The sealing arrangement may be an O-ring. Thus, repair material is conveniently transferred into the coating repair device.

The apparatus for delivering repair material to the coating repair device may be any suitable source of repair material. The apparatus may comprise a nozzle configured to deliver repair material into the injection through-hole. For example, the apparatus may be configured to do one or more of heating the repair material, stirring or mixing the repair material, mixing two or more different compounds, or activating the repair material. The apparatus may be configured to prepare the repair material for injection into the cavity. The apparatus may be, for example, a static mixer. The static mixer may comprise a mixing tube in communication with a nozzle. The nozzle may be disposed at a first end of the mixing tube, and therefore may be a tip of the static mixer. The static mixer may also comprise a dispenser in communication with a second end of the mixing tube, opposite the first end. The dispenser may be configured to urge repair material through the mixing tube and out of the nozzle. In some embodiments, the mixing tube may be configured to mix two components and deliver the mixed components to the nozzle as repair material. The nozzle may be configured to correspond with the shape of the fitting. Thus the nozzle and fitting may provide a fluid flow connection between one another with an interference fit. Accordingly, where the fitting defines an injection port, the injection port may be configured to receive the tip (nozzle). The static mixer may further comprise a heater. The heater may be configured to heat the repair material prior to use. Where the repair material is an epoxy resin, the repair material source may be an epoxy gun device configured to hold a releasable epoxy cartridge. Thus the repair material is introduced to the device using a static mixer, the provision of a heater can help to reduce the viscosity of the repair material to ensure it completely fills the cavity and speed up the repair process.

The coating repair kit may comprise an abrasion tool. The abrasion tool may be configured to abrade the coating. The abrasion tool may comprise a handle. The abrasion tool may comprise an abrasive surface. The handle and abrasive surface may be disposed at opposite ends of the abrasion tool. The abrasive surface may be sandpaper. The abrasion tool may be manual, battery, or electrically operated. Thus, the abrasion tool may be used to prepare the coating for repair by removing dirt that may affect the bonding and curing process of the repair material, and also by creating a rough surface on the coating that is easily and securely adhered to by the repair material.

The coating repair kit may comprise an abrasion template. The abrasion template may comprise an aperture corresponding to the inner section. The aperture may be the same size and shape as the inner section. The abrasion template may be annular with a shape that corresponds to the outer section. Thus, the abrasion template can be used to ensure a region around the periphery of the defect is abraded to provide a suitable surface for repair.

A bottom surface of the abrasion template may be formed from a non-slip material, for example rubber. The abrasion template may contain magnets/magnetic material and/or be magnetic. The abrasion template may therefore be retained in place on the coating due to its attraction to the metallic object beneath the coating to be repaired. Thus, the abrasion template may be used to accurately abrade the region that is going to be covered by the repair material without unnecessarily abrading other sections of the coating. The abrasion template is also less likely to slip or slide around when placed on the coating, this allows the region around the defect to be accurately and reliably abraded prior to repair.

According to a third aspect of the present disclosure there is provided a method of repairing a defect in a coating comprising the steps of: providing a coating repair device according to the first aspect of the present disclosure; fixing the coating repair device to the coating to form a cavity comprising the defect; injecting repair material into the cavity through the injection through-hole; curing or setting the repair material in the cavity; and removing the coating repair device from the coating.

The method may include any one or more of the features of the first and/or second aspects of the present disclosure as required or desired.

The method may comprise providing an abrasion tool, and abrading a region of the coating prior to repairing the coating. The method may comprise providing an abrasion template. The method may comprise locating the abrasion template on the coating, wherein an aperture of the abrasion template is centred on the defect so as to expose the defect through the aperture. The method may comprise abrading a region of the coating exposed through an aperture of the abrasion template. Thus, the region of the coating surrounding the defect is abraded prior to repair.

The method may comprise cleaning the coating. The step of cleaning may comprise abrading the coating. The step of cleaning may comprise removing abraded material from the coating. Thus, any left over abraded material is removed which ensures the repair material can effectively bond to the coating.

The method may comprise providing a coating repair device comprising an adhesive disposed on the bottom surface of the outer section, and a release liner provided over the adhesive. The method may comprise removing the release liner from the adhesive. Thus, the release liner ensures that the coating repair device and adhesive are protected from damage/interference due to other objects/dirt prior to use.

The method may comprise locating the injection through-hole of the coating repair device over the defect. The step of fixing may comprise forming a cavity with the defect in register with the injection through-hole. Thus, during use, repair material may exit the injection through-hole and proceed directly into the defect ensuring that it is completely filled and repaired.

The method may comprise fixing the coating repair device to the coating using the adhesive. The method may comprise sealing between a bottom surface of the outer section and the coating around a periphery of the inner section using the adhesive. Thus, a suitable cavity is formed to retain repair material in contact with the defect and the coating around the defect in order to form a durable and effective repair patch.

The method may comprise providing an apparatus for delivering repair material to the coating repair device. The method may comprise connecting the apparatus to the injection through-hole. The method may comprise connecting a nozzle of the apparatus to a fitting, or injection port, of the coating repair device. The method may comprise preparing repair material for delivery to the coating repair device. For example, depending on the repair material used this may involve one or more of heating the repair material, stirring or mixing the repair material, mixing two or more different compounds, or activating the repair material. The method may comprise preparing the repair material using the apparatus for delivering repair material.

The method may comprise urging repair material into the cavity. The method may comprise urging repair material into the injection through-hole. The method may comprise urging repair material out of the nozzle and into the cavity via the injection through-hole. The method may comprise injecting repair material into a centre of the cavity. Thus, the repair material is introduced into the cavity and may effectively fill it to repair the defect.

The method may comprise filling the cavity with repair material. The step of filling may comprise observing repair material in the cavity through a top surface of the inner section. The inner section may be translucent or transparent. The step of filling may comprise observing repair material emerging from the one or more relief through-holes. The step of filling may comprise injecting repair material into the cavity until repair material is observed emerging from the or each relief through-hole. Thus, the user can easily observe when the cavity has been completely filled and the injection process is complete.

The step of curing or setting may comprise waiting for a given period of time to pass. The step of curing may comprise initiating a curing reaction in the repair material. For example, the step of curing may comprise exposing the repair material in the cavity to an ultra-violet light, or a specific temperature to initiate the curing process. Thus, the method only proceeds once the repair patch has adequately cured.

The step of removing may comprise using a tab of the coating repair device to remove the coating repair device. The step of removing may comprise grasping the tab. The step of removing may comprise bending or flexing the coating repair device. The step of removing may comprise pulling the coating repair device away from the coating. The step of removing may comprise peeling the coating repair device off the coating from one side to the other. Thus, the flexibility of the device allows it to be slowly peeled from the coating which reduces the risk that the repair patch will be removed or damaged during the removal process.

The step of removing may comprise breaking the cured repair material in the injection through-hole at a location flush with the bottom surface of the inner section. The step of removing may comprise retaining cured repair material in the injection through-hole. Thus, the repair patch formed of cured repair material is smooth and less likely to be damaged, and furthermore, additional cured repair material is conveniently retained in the injection through-hole reducing post-repair cleaning.

According to a fourth aspect of the present disclosure there is provided a repair kit for coatings, membranes on metal substrates, comprising: a flexible member having top and bottom surfaces, said flexible member including an inner cavity membrane section peripherally surrounded by an outer annular membrane ring section, the inner cavity membrane section being attached around its outer periphery to an inner periphery of said outer annular membrane ring section with a bottom surface of said inner cavity section being raised above a bottom surface of said outer annular membrane ring section by height T, and including one or more air vent thru-holes located around the outer periphery of the inner cavity membrane section; an injection port attached to and located on said inner cavity membrane section configured to receive therein a dispensing tip of a resin dispensing device, said injection port located over a thru-hole located in the inner cavity membrane section to provide a flow path for resin dispensed from said resin dispensing device; and wherein in operation, upon affixing said bottom surface of the outer annular membrane ring section to the surface of the substrate with said inner cavity membrane section located over a defect in said substrate, an enclosed chamber is formed between the inner cavity membrane section and the surface of the substrate, the chamber having a depth substantially equal to said height T, and during injection of resin onto the surface of the substrate through said injection port air is vented out through said one or more vent holes to fill said chamber with resin, and upon curing of the resin, a patch is formed having dimensions substantially equal to the inner cavity membrane section and a thickness substantially equal to said height T.

The repair kit of the fourth aspect may include any one or more of the features of the first, second and third aspects of the present disclosure as required or desired.

### BRIEF DESCRIPTION OF THE DRAWINGS

In order that the disclosure may be more clearly understood one or more embodiments thereof will now be described, by way of example only, with reference to the accompanying drawings, of which:

FIG. 1 is a top view of a coating repair device for repairing damaged or defective coatings or membranes covering metal pipes, tank linings or structural steel to give a few non-limiting examples;

FIG. 2 is a cross sectional view of the coating repair device of FIG. 1 taken along the line A-A;

FIG. 3 is an expanded view of the Detail A in FIG. 2;

FIG. 4 is a bottom view of an adhesive liner for the coating repair device of FIG. 1;

FIG. 5 is a cross sectional view of the coating repair device of FIG. 1 along line A-A prior to use with the adhesive liner attached to the coating repair device;

FIG. 6 is an expanded view of the Detail B in FIG. 5;

FIG. 7A-D are cross sectional views of a coating defect being repaired using the coating repair device of FIG. 1; and

FIG. 8 is a perspective, disassembled view of an embodiment of the coating repair device and associated applicator instruments used to repair a coating defect in accordance with the present disclosure.

### DETAILED DESCRIPTION

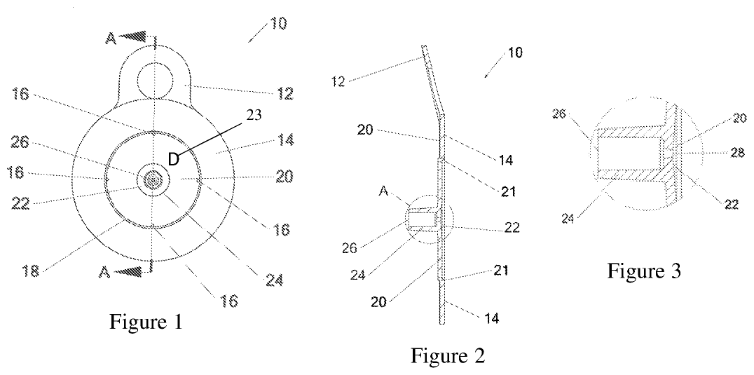

Referring to FIGS. 1-3, a coating repair device 10 comprises a generally planar flexible member having an outer section 14 and an inner section 20. In this embodiment, the outer section 14 is an annulus with an outer diameter of 63.0 mm and an inner diameter of 38.5 mm, and the inner section 20 is a circle with diameter 38.5 mm. The outer circumference 18 of the inner section 20 is attached to the inner perimeter of the outer section 14. As such, the axes of both the outer section 14 and inner section 20 are parallel, and in this embodiment, the axes also correspond to the axes of the coating repair device 10.

The plane defined by a bottom surface of the inner section 20 is offset and recessed with respect to the plane defined by a bottom surface of the outer section 14. In this embodiment, the offset is 0.636 mm, but in other embodiments it may be 0.5-2 mm. Due to this offset, a bottom surface of the coating repair device 10 is defined by the bottom surfaces of the inner section 20 and outer section 14, and has a stepped profile, stepping down from the outer section 14 to the inner section 20, and stepping up from the inner section 20 to the outer section 14. Thus, when the bottom surface of the outer section 14 is placed on a coating to be repaired, the recessed inner section 20 defines a cavity that can be filled with repair material to repair the defect.

The inner section 20 comprises a chamfered outer periphery 21 connecting the outer section 14 and inner section 20. The outer periphery 21 has a radial extent in the plane of the bottom surface of the inner section 20 of 0.5 mm, and is chamfered at an angle of 45 degrees to the plane of the bottom surface of the outer section 14. In other embodiments, the chamfered outer periphery 21 may have different dimensions.

The inner section 20 also comprises a circular raised section 22 positioned centrally in the inner section 20. The raised section 22 has a diameter of 12.7 mm. In the raised section 22, the bottom surface of the inner section 20 has a conical shape, with the tip of the cone located on the axes of the inner section 20 and outer section 14. The tip of the cone is recessed from the bottom surface of the inner section 20 by 0.3 mm, and is therefore the point recessed furthest from the bottom surface of the outer section 14. In other embodiments, the dimensions of the raised section 22 may be different to suit the circumstances.

The coating repair device 10 also comprises an injection through-hole 28 that extends from a top surface of the coating repair device 10 to its opposite bottom surface. The injection through-hole 28 is located at the centre of the inner section 20 of the coating repair device 10 and therefore truncates the cone formed by the bottom surface of the inner section 20. The injection through-hole 28 tapers, such that it narrows, as it approaches the bottom surface of the inner section 20 of the coating repair device 10. The injection through-hole 28 extends along the axis of the inner section 20 from its top surface to its opposite bottom surface. The injection through-hole 28 has a tapered shape and is therefore also a truncated cone with an upper width on the top surface of the coating repair device 10 greater than a lower width on the bottom surface of the coating repair device 10. In this embodiment, the lower width is 0.821 mm but in other embodiments the width of the injection through-hole 28 at the bottom surface of the coating repair device 10 may be any suitable size, such as 0.5-2 mm.

A fitting 24 is disposed on the top surface of the coating repair device 10 over the injection through-hole 28 in the top surface of the coating repair device 10. The fitting 24 is tubular, having an annular cross-section when viewed parallel to the axis of the injection through-hole 28 and extends away from the top surface of the coating repair device 10. The fitting 24 forms an injection port 26 that communicates with the injection hole 28. The fitting 24 is tapered such that its inner diameter increases as the distance from the injection through-hole 28 increases, and its outer diameter decreases. In this embodiment, the inner diameter increases from 4.2 mm at a proximal end of the fitting 24 adjacent the injection through-hole 28 to 4.3 mm at a distal end opposite the proximal end.

As described above, the fitting 24 and injection through-hole 28 thereby allow an apparatus for delivering repair material to be connected to the coating repair device 10, and for liquid repair material be passed through the coating repair device 10 from its top surface to its bottom surface. The repair material will also be introduced by the injection through-hole 28 at the centre of the recessed bottom surface of the inner section 20 of the coating repair device 10. Thus, where the defect is aligned with the centre of the inner section 20, repair material may pass directly from the injection through-hole 28 into the defect.

In other embodiments, the fitting 24 and injection through-hole 28 may allow the apparatus for delivering repair material to be connected to the coating repair device 10 at various different angles with respect to the top surface of the coating repair device 10 and at various different locations on the top surface of the coating repair device 10 to suit the circumstances.

Around the outer circumference 18 of the inner section 20 are disposed four relief through-holes 16 that extend parallel to the axis of the inner section 20 from the top surface of the coating repair device 10 to its opposite bottom surface. The relief through-holes 16 are each spaced at equal points around the outer circumference 18 of the inner section 20. In other embodiments, more or fewer relief through-holes 16 may be used and at positions not necessarily on the outer circumference 18 of the inner section 20, as required. In this embodiment, each relief through-hole 16 has a constant diameter of 1 mm along its axis, in other embodiments this may be different. The relief through-holes 16 thereby allow air or repair material to pass between the top and bottom surfaces of the coating repair device 10. Specifically, in use, they allow air to be displaced from the cavity formed by the inner section 20, outer section 14, and coating to be repaired while repair material is injected into the cavity through the injection through-hole 28.

In this embodiment, the coating repair device 10 also comprises a tab in the form of a thumb grab 12 attached to one side of the outer circumference of the outer section 14. The thumb grab 12 is annular with an outer circumference that is smaller than the outer circumference 18 of the inner section 20. The axis of the thumb grab 12 is angled with respect to the axis of the inner section 20 such that their axes converge at a point above the top surface of the coating repair device 10.

In this embodiment, the entire coating repair device 10 is formed in a single step by curing a plastics material in a mould corresponding to the shape of the coating repair device 10. However, in other embodiments, the different parts may be formed separately and then joined together to form the coating repair device 10.

In this embodiment, the inner section 20, outer section 14 and thumb grab 12 all have the same thickness of 1.3 mm. As such, the top surface of the coating repair kit 10 has the same profile as the bottom surface of the coating repair kit 10. In alternative embodiments, the thickness of each section may vary such that the profile of the top surface does not correspond to that of the bottom surface of the coating repair kit 10. For example, the thickness may depend on the overall size of the coating repair device 10, for example it may be between 0.8-3 mm.

In this embodiment, the coating repair device 10 additionally comprises an indicia 23 formed in relief on the bottom surface of the inner section 20.

Advantageously, this allows a corresponding indicia to be formed on the surface of the repair patch once formed in use. In this embodiment the indicia 23 is the letter “D”, to signify that the repair patch is covering a defect. In alternative embodiments many other types of indicia may be used alone or in combination such as: the date or time of repair, the materials used in the repair, branding or trade marks, serial numbers, etc.

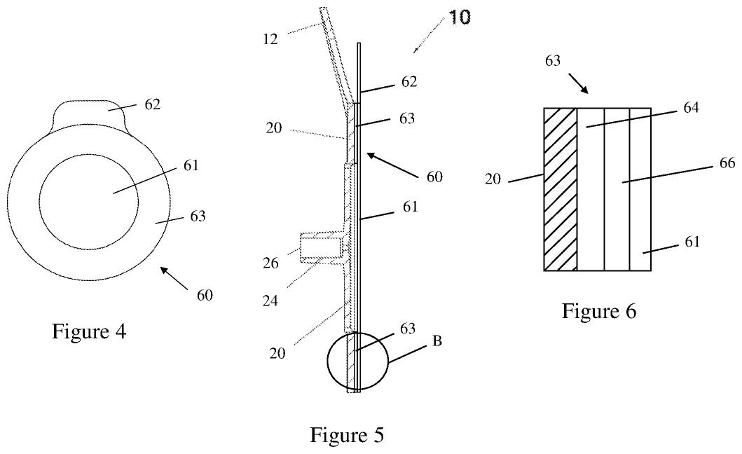

Referring to FIGS. 4-6, prior to use, an adhesive 60 is attached to the bottom surface of the coating repair device 10. The adhesive 60 comprises a circular impermeable release liner 61 with an outer diameter that matches that of the outer section 14, and an annular adhesive film 63 with the same inner and outer diameter as the outer section 14. The adhesive 60 also comprises a rectangular release flap 62 that extends from one side of the release liner 61. The release flap 62 is configured to allow the release liner 61 to be separated from the adhesive film 63.

In this embodiment, the adhesive film 63 is a double-sided adhesive and comprises two layers: a device adhesive 64; and a coating adhesive 66. The device adhesive 64 is configured to adhere the adhesive film 63 to the bottom surface of the coating repair device 10. The coating adhesive 66 is configured to be releasably adhere to the release liner 61 and a surface of a coating to be repaired. Preferably, the bonding strength between the device adhesive 64 and the coating repair device 10 is stronger than between the coating adhesive 66 and the surface of the coating to be repaired.

Advantageously, this allows the coating repair device 10 to be removed from the coating while retaining the adhesive 60 on the coating repair device 10 and without leaving adhesive residue on the coating.

The adhesive film 63 is aligned in register with the release liner 61, with the release liner 61 attached to the coating adhesive 66. As such, the adhesive 60 may be attached to the bottom surface of the coating repair device 10 using the device adhesive 64.

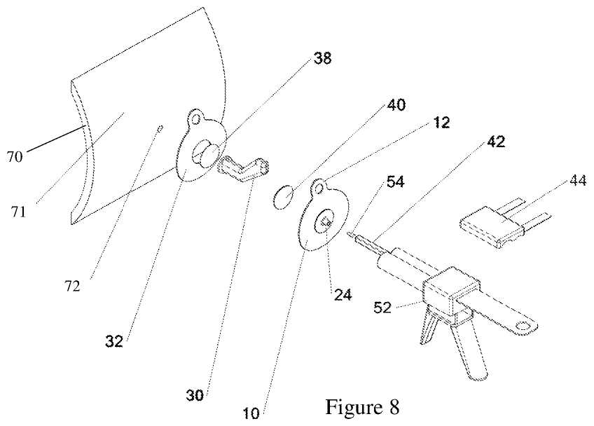

Referring to FIG. 8, this embodiment of the disclosure is configured to be used as part of a coating repair kit comprising a static mixer. As such, the entrance of the injection port 24 is configured to receive a tip 54 located at the end of the static mixer. The static mixer also comprises a mixing tube 42 in communication with, and attached at one end to, the tip 54. The mixing tube 42 is attached at its other end to a dispenser 52 which is used to dispense repair material through the mixing tube 42 and out of the tip 54 into the injection port 24. The injection port 24 is a similar shape of the tip 54 of the static mixer and may have an O-ring in the end to prevent repair material escaping between the tip 54 and injection port 24, and prevent air from entering the cavity during injection of repair material. The static mixer further comprises an optional heater 44 configured to heat the repair material prior to use. This can help to reduce the viscosity of the repair material to ensure it completely fills the cavity and speed up the repair process. Depending on the type of repair material used, the heater 44 may also be required to ensure the repair material is at the correct operational temperature prior to use.

The coating repair kit also includes an abrasion tool 30 and corresponding abrasion template 32. The abrasion tool 30 comprises a handle at one end and an abrasive surface at the other, such as sandpaper. The abrasion template 32 is annular with a shape that corresponds to the outer section 14. The abrasion tool 30 may be manual, battery or electrically operated.

A bottom surface of the abrasion template 32 may be formed from a flexible non-slip rubber. Furthermore, the abrasion template 32 is magnetic, made of magnetic materials, or contains magnets so as to temporarily attract the abrasion template 32 to metallic surfaces. Thus, the abrasion template 32 is less likely to slip or slide around when placed on the coating 71.

Referring to FIGS. 1-8, a coating 71 for a surface 70 comprises a defect 72. In this example, the surface 70 may be a metal pipe, and the coating 71 may be a protective layer of paint. The coating repair device 10 may be used to repair the defect 72 as described below.

The abrasion template 32 is placed over the defect 72, exposing the defect 72 and the coating 71 immediately surrounding the defect 72 through the aperture in the centre of the abrasion template 32. The abrasion tool 30 is used to abrade the exposed coating 71 in a patch that corresponds to the final shape and size of the repair patch 73. The shape/size of the abraded area is indicated by disk 38 in FIG. 8. This abrasion simultaneously removes dirt from the coating 71 and reduces the risk of premature delamination of the repair patch 73 from the coating 71, as the coating 71 is primed with a rough surface that the repair material can securely adhere to. Following abrasion, the abraded area may be cleaned to remove any debris caused by the abrasion process, for example using a stream of air or wiping across the surface.

The coating 71 is now ready for the coating repair device 10 to be attached to it. Prior to use, the adhesive 60 is attached to the bottom surface of the coating repair device 10. In this configuration, the entire bottom surface of coating repair device 10 is covered by the release liner 61 and as such, is not able to adhere to the coating 71. Advantageously, in this state the release liner 61 prevents dirt or other objects from touching the bottom surface of the inner section 20, which may interact with the repair processes and detrimentally affect the performance of the coating repair device 10. It also prevents the adhesive film 63 from touching objects prematurely and thereby reducing its capacity to adhere to the coating 71.

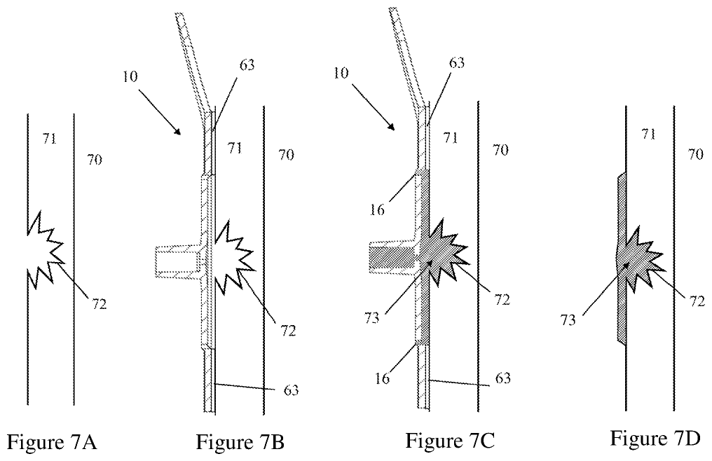

The release flap 62 may be used to separate the release liner 61 from the adhesive film 63 and the coating repair device 10. Referring to FIG. 7B, the coating repair device 10 may now be adhered to the coating 71 by placing the injection through-hole 28 in register with the defect and lowering the bottom surface of the coating repair device 10 onto the coating 71. In doing so, the coating adhesive 66 will contact with the coating 71 and adhere the coating repair device 10 to the coating 71.

Once the coating repair device 10 is adhered to the coating 71 as described above, the recessed bottom surface of the inner section 20 will form a cavity with the coating 71 and the defect 72, the cavity being sealed about its periphery by the adhesive film 63. Referring to FIG. 7C, repair material may now be introduced to the cavity through the injection through-hole 28, which introduces the repair material in the centre of the inner section 20. The cavity therefore defines the repair area 40 (see FIG. 8) that is covered by the repair material, and this area corresponds to the area of the coating 71 that has been abraded.

In this embodiment, repair material is introduced through the injection though-hole 28 by connecting a source of repair material to the injection port 24. Repair material is introduced into the cavity until the cavity is filled with repair material. As repair material enters the cavity it may spread radially from the centre of the inner section 20 due to the geometry of the injection through-hole 28 and the cavity, in particular the shape of the bottom surface of the inner section 20. The relief through-holes 16 disposed on the outer circumference 18 of the inner section 20 allow air to escape the cavity, preventing a pressure increase in the cavity and permitting additional repair material to enter the cavity. Once the cavity is filled, the relief through-holes 16 are the final part of the cavity to be filled with repair material. As such, repair material can be introduced into the cavity until it is observed emerging from one or more of the relief through-holes 16, signifying that the cavity is full of repair material.

Where the inner section 20 and/or coating repair device 10 is made of a translucent or transparent material, the process of filling the cavity with repair material may also be followed by observing the repair material through the inner section 20 of the coating repair device 10. Advantageously, this may allow for errors or abnormalities, such as air bubbles in the cavity to be identified

In this embodiment, repair material is introduced by connecting the tip 54 of the static mixed to the injection port 26. The tip 54 is connected by pushing the tip 54 into the injection port 26 to form an interference fit. The dispenser 52 is then used to urge repair material out of the tip, through the injection through-hole 28 and into the cavity. This process continues until repair material is visible emerging from all four relief through-holes 16, or where the inner section 20 is translucent/transparent, until the cavity is observed through the inner section 20 to be full of repair material.

Once the cavity is full of repair material, the coating repair device 10 remains adhered to the coating 71 until the liquid repair material has set or cured solid into a repair patch 73. Referring to FIGS. 7C and 7D, once the repair patch 73 has set/cured, the coating repair device 10 may be removed from the coating 71 by grasping the thumb grab 12 that is projecting away from the coating 71, and pulling the coating repair device 10 away from the coating 71. Advantageously, the flexible nature of the coating repair device 10 allows it to be progressively peeled back from the coating 71. This reduces the risk of damage to the repair patch 73. Furthermore, the chamfered edge of the inner section 20, conical shape of the inner section 20 close to its axis, and the tapered narrowing width of the injection through-hole 28 ensure that that the coating repair device 10 may be removed from the coating 71 leaving the repair patch 73 undamaged and attached to the coating 71 and defect 72.

In particular, the tapered shape of the injection through-hole 28 ensures that a local point of weakness in the set repair material is on, or adjacent to, the bottom surface of the inner section 20. This ensures the repair material breaks at this point during removal of the coating repair device 10 leaving the outer edge of the repair patch 73 smooth at this point. The tapered shape also ensures that no additional set/cured repair material falls out of the injection through-hole 28 during removal.

As mentioned above, the bond created between the device adhesive 64 and the coating repair device 10 is preferably stronger than a bond created between the coating adhesive 66 and a surface of a coating to be repaired. This allows the coating repair device 10 to be removed from the coating 71 without leaving behind any layers from the adhesive film 63.

Referring to FIG. 7D, the repair patch 73 is retained on the coating 71 and fills the defect 72 reducing the risk that the surface 70 will be damaged in future.

Advantageously, the chamfered edge of the inner section 20 creates a chamfered edge to the repair patch 73 that reduces the likelihood that soil and liquid stresses will damage the repair patch 73 or coating 71.

The conical shape of the inner section 20 close to its centre also results in a thicker section of the repair patch 73 at its centre, and in register with the centre of the defect 72. This improves the performance of the repair patch 73 as it is stronger in this region and is less likely to be pulled out of the defect during removal of the coating repair device 10 from the coating.

The repair material may be made of any one or combination of epoxies, urethanes, ultra-violet curing compounds or other resinous materials.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The one or more embodiments are described above by way of example only.

Many variations are possible without departing from the scope of protection afforded by the appended claims.

1. A coating repair device comprising a flexible member having an inner section peripherally surrounded by an outer section, the inner and outer sections each having top and bottom surfaces with the bottom surface of the inner section being recessed with respect to the bottom surface of the outer section, such that when the flexible member is, in use, placed on a surface of a coating to be repaired the flexible member defines a cavity with the surface, and an injection through-hole extending between a top surface of the device and the bottom surface of the inner section for the introduction of repair material into the cavity, in use, and one or more relief through-holes extending between the bottom surface of the inner section, at the outer periphery of the inner section, and a top surface of the device through which, in use, displaced air or surplus repair material may flow out of the cavity.

2. A device as claimed in claim 1 wherein a connection between the outer section and inner section is chamfered.

3. A device as claimed in claim 1 wherein a portion of the bottom surface of the inner section surrounding the injection through-hole is recessed with respect to a remaining portion of the bottom surface of the inner section.

4. A device as claimed in claim 1 wherein the injection through-hole is tapered.

5. A device as claimed in claim 1 wherein the injection through-hole narrows as it approaches the bottom surface of the inner section.

6. A device as claimed in claim 1 wherein the bottom surface of the inner section is smooth.

7. A device as claimed in claim 1 wherein at least part of the coating repair device is translucent or transparent.

8. A device as claimed in claim 1 comprising an indicia formed in relief on the bottom surface of the inner section.

9. A device as claimed in claim 1 comprising a tab configured to allow the coating repair device to be removed from a coating after use.

10. A device as claim in claim 9 wherein the tab is angled with respect to the axis of the inner and outer sections.

11. A device as claimed in claim 1 comprising an adhesive disposed on the bottom surface of the outer section configured to provide a seal between the bottom surface of the outer section and a coating to be repaired in use.

12. A device as claimed in claim 11 wherein the adhesive is configured such that, in use, the bond between the adhesive and the coating repair device is stronger than the bond between the adhesive and the coating to be repaired.

13. A device as claimed in claim 11 comprising a release liner provided over the adhesive and configured to cover the bottom surface of the inner section and the outer section.

14. A device as claimed in claim 1 wherein the inner section is circular and the outer section is an annulus.

15. A device as claimed in claim 1 wherein a majority of the bottom surface of the inner section is recessed from the bottom surface of the outer section by a given height, T, wherein T is at least 0.25 mm.

16. A device as claimed in claim 1 comprising two or more relief through-holes equally spaced around a periphery of the inner section.

17. A device as claimed in claim 1 comprising a fitting provided on a top surface of the inner section in communication with the injection through-hole.

18. A device as claimed in claim 17 wherein the fitting is configured to allow an apparatus for delivering repair material to the coating repair device to be received by the coating repair device at various angles with respect to the top surface of the inner section.

19. A coating repair kit comprising: the coating repair device as claimed in claim 1; an abrasion template comprising an aperture corresponding to the shape and size of the inner section; and an abrasion tool.

20. A method of repairing a defect in a coating, the method comprising the steps of: providing either a coating repair device as claimed in claim 1; fixing the coating repair device to the coating to form a cavity comprising the defect; injecting repair material into the cavity through the injection through-hole; curing or setting the repair material in the cavity; and removing the coating repair device from the coating.
